(19) United States
(12) Patent Application Publication
(10) Pub. No.: US 2021/0110740 A1
(43) Pub. Date: Apr. 15, 2021

(54) DEVICE FOR DISPLAYING ARTICLES WITH MAGNETIC FASTENING

(71) Applicant: LEGAMI S.R.L., Azzano S. Paolo (BG) (IT)

(72) Inventor: Alberto Fassi, Bergamo (IT)

(21) Appl. No.: 16/603,281

(22) PCT Filed: May 17, 2018
(86) PCT No.: PCT/EP2018/062869

§ 371 Date: Oct. 7, 2019

(30) Foreign Application Priority Data
May 18, 2017 (IT) 102017000053774

(51) Int. Cl. G09F 7/04; G09F 1/10; G09F 15/00; G09F 7/18

(52) U.S. Cl. CPC G09F 7/04; G09F 1/10; G09F 2007/186; G09F 7/18; G09F 2007/1852; G09F 15/0062

(57) ABSTRACT

The present invention relates to a device for displaying articles, such as photographs or postcards, wherein the articles are fixed with magnetic fastening comprising: a metal wire provided with a coupling means at one end and with a terminal element, larger than the diameter of the metal wire, at the opposite end; at least one permanent magnet provided with a hole suitable for insertion of the metal wire; at least one metal fastening element, movable and couplable to the magnet; wherein the articles are fixed between the magnet and the metal fastening element.

The present invention relates to a device for displaying articles with magnetic fastening. In particular, it relates to a photograph holder device or similar provided with a series of magnets suitable to support these objects.

As is known, numerous types of photograph holders of various shapes and sizes exist.

Typically, photograph holders can be of the type with a frame, i.e., provided with an external border suitable to frame the photograph or photographs to be displayed, or photograph holders with clips or the like, where the photograph is supported by means of coupling devices that are capable of displaying the photo without the need to insert it in a frame.

Currently, numerous types of photograph holders with clips exist, both by virtue of the materials used and of the type of coupling they offer.

Photograph holders that exploit a series of permanent magnets associated with metal elements in order to secure and retain the photograph to be displayed are very common.

The main characteristic of this type of photograph holder is that of having a clean and minimal line that permits them to be used in any environment, whether furnished in classic or modern style.

These photograph holders are also practical to use and permit the photograph displayed, or the series of photographs displayed, to be replaced easily and without the need to remove parts of the photograph holder or to use tools to remove the photograph.

Photograph holders provided with a metal wire to which a series of permanent magnets can be attached in order to secure the photographs to be displayed are currently available on the market. These magnets can be plain magnets or they can be associated with other metal or plastic elements in order to improve the appearance of the magnet and simultaneously facilitate gripping and positioning on the metal wire

However, this type of photograph holder has some problems, in particular linked to the safety and to the usability of these photo holders in domestic environments. In particular, the fact that the permanent magnets can be detached from the metal wire, and can therefore be freely handled and also used not in close association with the wire, makes them unsafe for use in environments in which infants or young children, who could accidentally come into contact with the magnets, are present.

In fact, the use of loose permanent magnets is a risk factor for infants and young children, as they could be swallowed or used inappropriately, seriously endangering their health.

Moreover, permanent magnets can be harmful for some electronic appliances, such as mobile phones, PC, tablet or smartphone monitors, or for the magnetic strip of credit or debit cards. These objects can be damaged permanently if subjected to the magnetic field exerted by the magnets used to support the photographs, even if of small size and with a weak magnetic field.

In this regard, there are some ministerial directives that limit the sale and domestic use of permanent magnets, in order to protect the health of citizens, and in particular of children, and prevent them from endangering health or damaging domestic objects. These limits relate to the intensity of the magnetic field that a permanent magnet for domestic use may have, as magnets of small sizes but with a strong magnetic field can be potentially more harmful than magnets of large sizes but with a weak magnetic field.

U.S. Pat. No. 8,215,598 describes a hanging display device for displaying an item that includes a magnet system comprising first half magnets disposed along a cable. The first half magnets are for engaging second half magnets, which are disposed on the items. A user can simply connect the magnets together to temporarily attach the item to the cable.

In said device the magnets can be detached from the metal wire, and can therefore be freely handled and also used not in close association with the wire as previously stated.

In the state of the art, there is the need for technical solutions that permit the problems of the prior art described above to be solved.

The main aim of the present invention is to provide a device for displaying articles with magnetic fastening that permits the problems of prior art described above to be solved.

Within this aim, an object of the present invention is to produce a device for displaying articles with magnetic fastening where the magnets are not detached, but constrained to the structure so that they cannot be handled without care.

A further object of the present invention is to produce a device for displaying photographs or the like that permits the photographs to be displayed to be positioned easily in any point of the photograph holder, without the risk of being accidentally moved.

Yet another object of the present invention is to produce a device for displaying photographs that complies with the regulations concerning the use of permanent magnets, at the same time maintaining characteristics of high strength and usability.

One more object of the present invention is to produce a strong and lasting photograph holder, which can be used in any environment and easily fixed to the wall or to other furnishing components.

Yet another object of the present invention is to produce a device for displaying articles with magnetic fastening that enables a reduction in production costs and consequently maintain a sales price appropriate for the type of product.

This aim and these objects, together with other objects that will be more apparent from the subsequent description and from the accompanying drawings, are achieved according to the invention by a device for displaying articles with magnetic fixing according to claim 1 and to the related dependent claims appended below.

The display device according to the invention comprises a metal wire provided with a coupling means at one end and with a terminal element, larger than the diameter of the metal wire, at the opposite end; at least one permanent magnet provided with a hole suitable for insertion of the metal wire; at least one metal fastening element, movable and couplable to the magnet; wherein said articles are fixed between said magnet and said metal fastening element.

Preferably the metal wire (10) has a diameter between 1 and 3 mm. In this way, a strong and sturdy product is provided, capable of supporting a large number of photographs or similar articles to be displayed without the risk of the wire breaking or becoming deformed.

Preferably, the metal wire is inserted into the hole of the magnet so that this magnet can be slidably movable along the metal wire and even more preferably the hole of the magnet has a diameter such that it permits a coupling with mechanical play to the metal wire. In this way it is possible to modify the position of the magnet along the length of the metal wire permitting the photographs displayed to be positioned in the most appropriate or desired position.

Preferably, the magnet has a magnetic field from 3000 to 5000 Gauss, even more preferably from 3500 to 4000 Gauss. In this way, a display device that complies with the current regulations on the subject of magnetic field of permanent magnets suitable for use in a domestic environment is provided, at the same time ensuring an adequate hold of the magnets on the metal wire to support the photograph or the like to be displayed.

Preferably the magnet is a perforated monobloc magnet. In this way, a single magnet that is not subject to possible separations caused by incorrect assembly or excessive wear is provided.

Preferably the terminal element provided on the metal wire has a weight such that the metal wire is kept extended. In this way, the display device is always kept in an appropriate position and permits the photographs to be correctly and appropriately displayed.

Preferably, the metal wire (10) is made up of a bundle of metal wires wound in a coil. In this way a particularly flexible and strong metal wire is provided, which permits the photographs to be easily and effectively displayed.

Further characteristics and advantages of the display device according to the present invention will be better understood by referring to the description below and to the accompanying drawings, which are provided purely by way of non-limiting example, wherein:

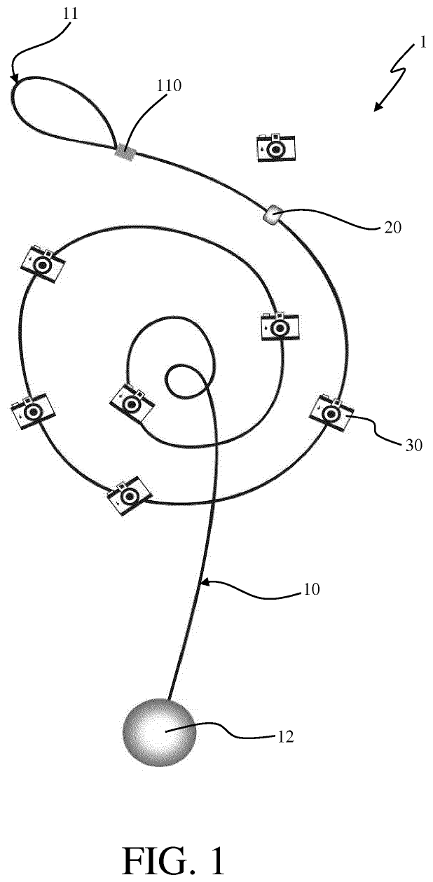

FIG. 1 is an overall view of the display device according to the present invention;

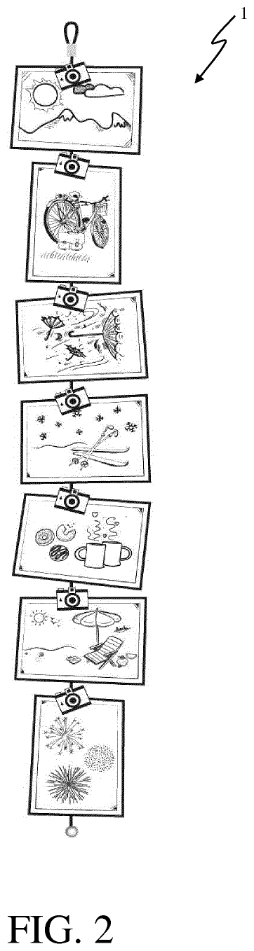

FIG. 2 is an overall view of the display device of FIG. 1 provided with a series of photographs/postcards displayed;

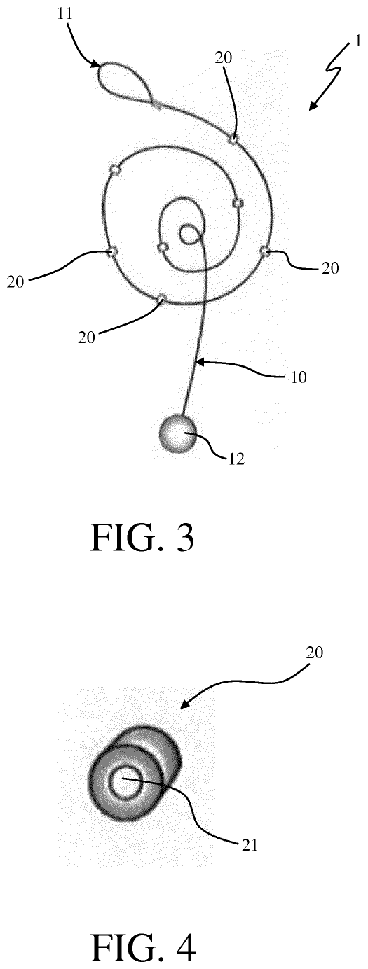

FIG. 3 is a schematic view of the metal wire, with which the display device according to the present invention is provided, equipped with a series of permanent magnets;

FIG. 4 is a perspective view of a perforated magnet with which the display device according to the present invention is provided;

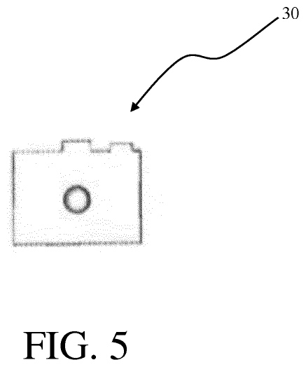

FIG. 5 is a front view of the metal fastening element with which the display device according to the present invention is provided.

With reference to the aforesaid figures, the present invention relates to a device for displaying articles 1 with magnetic fastening. The term display device according to the present invention means a device suitable for displaying photographs, postcards or any articles related thereto, which hereinafter will be generically defined as photograph holder.

The photograph holder according to the invention comprises, in an embodiment thereof illustrated generically in FIG. 1, a metal wire 10 of variable length according to the display needs of the user, provided with coupling means 11 at one end, suitable to support the whole photo display device and to permit correct fixing to a wall or to a piece of furniture present in the room in which the photographs are to be displayed. This fixing can take place by means of common fixing means, such as nails, screws provided with screw anchors, etc.

This coupling means can be coupled to the metal wire, such as an actual hook or a ring, or can be advantageously produced by means of the wire, as illustrated in FIGS. 1 and 3. This coupling means in the embodiment illustrated, consists of a slot 11 produced by means of the metal wire and fixed by means of a specific fixing means 110 to the wire. In this way a practical and strong coupling means is produced, capable of supporting the weight of the whole photo holder even when numerous articles are displayed. This solution is also particularly advantageous from the point of view of cost, as it does not require extraneous and cumbersome means, but is produced by means of a portion of the wire.

The metal wire 10 is further provided with a terminal element 12, placed at the opposite end of the wire with respect to the coupling means 11, of larger size with respect to the diameter of the wire. This terminal element functions as a stop or limit stop for the series of permanent magnets through which the metal wire is made to pass, as will be clearly illustrated below.

In the embodiment illustrated in the accompanying figures, the terminal element 12 has a weight such that the metal wire is kept extended, i.e., has a size and a mass such as to permit the wire to remain in tension due to the combined effect of the mass of the element and the force of gravity. This solution permits any type of photograph or postcard to be displayed easily, due to the stability of the metal wire that constantly keeps the necessary tension to prevent the wire from coiling and thereby decreasing its length on the wall to which it is fixed.

The metal wire 10 preferably has a diameter between 1 and 3 mm, so as to ensure both strength and therefore permit articles of different materials and weight to be displayed, and to maintain a reduced and appropriate weight of the display device so that fixing means of large size are not required.

In a preferred embodiment, the metal wire 10 is made up of a bundle of metal wires coiled around themselves, so as to obtain a more manageable and less rigid wire that, if accidentally bent, has no bend points that could interrupt sliding of the magnets, as will be described below.

The device according to the present invention further comprises at least one permanent magnet 20 provided with a hole 21 suitable for insertion of the metal wire 10 into the hole.

The metal wire 10 is therefore inserted into the hole 21 of the magnet 20, so that the magnet 20 can be slidably movable along the whole of the length of the metal wire 10, i.e., from the coupling element to the terminal element, so that it can be positioned along the whole of the length of the wire based on the using needs and on the overall dimensions of the photographs to be displayed.

In order to permit correct sliding of the magnet 20 along the metal wire 10, the hole 21 has a diameter such that it permits a coupling with mechanical play to said metal wire 10. The term coupling with mechanical play, according to the present invention, means coupling in which the minimum size of the hole is greater or, at most, the same as the maximum size of the metal wire (Dmin≥dmax, where D is the diameter of the hole and d is the diameter of the metal wire).

The magnet exerting its magnetic field in relation to the metal wire, after having been positioned, remains in the desired position and does not slide toward the lower end of the wire due to the force of gravity that attracts it downward. This permits the photograph to be displayed to be positioned easily without the need for further systems for blocking the magnet that could damage and cause premature wear on the metal wire.

Based on the magnitude of the magnetic field of the perforated magnet, it is possible to display photographs or postcards even of large size and weight. According to the present invention the magnetic field is from 3000 to 5000 Gauss so as to ensure that even photographs or postcards of large size and weight can be displayed. Preferably, the magnet has a magnetic field from 3500 to 4000 Gauss so as to support objects of variable size, and to comply with the standards established by law on the subject of permanent magnets for domestic use.

In this regard, the magnetic field is subject to limitations imposed by the applicable legislation for analysis of the safety of the magnet in order to protect and safeguard the health and safety of users.

As the device can be used by different users, i.e., both by adults and children, the strictest applicable legislation on the subject of safety is the legislation regarding toys.

With regard to the European market the standard is: EN71-1:2014 Mechanical and physical properties. Clause 4.23.

For the American market: ASTM F963-11: Mechanical & physical properties. Clause 4.38.

The maximum limit of the magnetic field in proportion to the size of the magnet is 50 kG mm².

The magnetic field is specifically modulated on the volume of the magnet used in the device and on the interaction that the magnet has to be with the metal wire.

Said magnetic field allows to hold up the photographs or postcards and at the same time allows to move two magnets close to each other (until 2-2.5 cm) without the interference of the two magnetic field, i.e. that the magnetic field of one magnet attracts or repulses the other magnet.

In a preferred embodiment the magnet is a perforated monobloc magnet, i.e., is made up of a single piece of permanent magnet in which the hole required for passage of the metal wire is made. This solution makes it possible to ensure a high strength of the magnet, preventing or greatly reducing the probability of detachment from the metal wire caused by breakage or decoupling of coupled parts.

In order to permit the display of photographs or postcards, the photograph holder comprises at least one metal fastening element 30 removable and couplable to the magnet 20.

The photographs are therefore kept in position through fixing between the magnet 20 and the metal fastening element 30, i.e., the photograph is “clamped” between the two elements and this way remains suspended and constrained to the metal wire 10.

The interaction that occurs between the metal element 30 and the magnet 20 permits any type of material, with any kind of shape, to be supported. The force that permits the photograph to be supported is a function both of the magnetic field exerted by the magnet 20, and of the size of the magnet 20 and of the metal fastening element 30.

The metal element 30 is made of a ferrous metal, i.e., a metal capable of withstanding interaction of the magnetic field generated by the magnet 20 in order be able to secure and block the object displayed.

The use of element 30 makes the device safe also for kids use or in general for household use.

In a preferred embodiment, the photo holder comprises several perforated magnets provided with a corresponding metal fastening element, so as to permit the simultaneous display of several photographs or postcards.

In an embodiment not shown, the metal element 30 is coated with a coating of plastic material, such as polyethylene, polypropylene, polystyrene, polyvinyl chloride, polyesters, silicones, polyurethanes. In this way the fastening element is protected and isolated, which ensures a greater level of safety for the user, who in this way does not risk cuts or abrasions caused by any projecting or sharp parts of the element. The coating can also have an aesthetic function to make the product more attractive, shaping it with shapes or designs of various type.

1.-9. (canceled)

10. A device for displaying articles with magnetic fastening, comprising:
a metal wire comprising a coupling means at a first end, and a terminal element, larger than the diameter of said metal wire, at a second and opposite end;
at least one permanent magnet provided with a hole suitable for insertion of said metal wire; and
at least one metal fastening element removable from and couplable to said magnet, wherein said articles are fixed between said magnet and said metal fastening element.

11. The display device of claim 10, wherein said metal wire has a diameter between 1 and 3 mm.

12. The display device of claim 10, wherein said hole of said magnet has a diameter such that it permits a coupling with mechanical play to said metal wire.

13. The display device of claim 10, wherein said magnet has a magnetic field from 3000 to 5000 Gauss.

14. The display device of claim 13, wherein said magnetic field is from 3500 to 4000 Gauss.

15. The display device of claim 10, wherein upon said metal wire being inserted into the hole of said magnet, said magnet is slidably movable along said metal wire.

16. The display device of claim 10, wherein said magnet is a perforated monobloc magnet.

17. The display device of claim 10, wherein said terminal element of said metal wire has a weight such that the metal wire is kept extended.

18. The display device of claim 10, wherein said metal wire is made up of a bundle of metal wires.
